(19) United States
(12) Patent Application Publication
(10) Pub. No.: US 2003/0140079 A1
(43) Pub. Date: Jul. 24, 2003

(54) Multiple number representations for multiplication complexity reduction in signal processing transforms

(76) Inventor: Charles Douglas Murphy, Chicago, IL (US)

Correspondence Address: CHARLES DOUGLAS MURPHY, 601 LINDEN PLACE #210, EVANSTON, IL, 60202, US

(21) Appl. No.: 10/050,293

(22) Filed: Jan. 18, 2002

(51) Int. Cl. G06F 7/52

(52) U.S. Cl. 708/620

(57) ABSTRACT

A machine or method used in signal processing transforms that involve computing one or more sums each of one or more products. Multiplication for one product is implemented using one machine or method, and multiplication for a second product is implemented using a machine or method that is not capable of computing the first product. Alternatively, the numbers used in computing one product have a pair of finite-precision numeric formats that is not the same as the pair of finite-precision numeric formats of numbers used in computing a second product. Which machine or method is used depends on the particular representation of one or both numbers being multiplied, and on common properties of groups of allowed input number values and representations. The invention allows signal processing transforms with lower complexity than if a multiplication machine or method for the second product must also be able to compute the first product and with lower complexity than if all pairs of numbers that are multiplier inputs are required to have the same finite-precision numeric format pair.

PROCESSING TRANSFORMS submitted as a separate application by Charles D. Murphy. The invention is also related to DESIGNING SIGNAL PROCESSING TRANSFORMS WITH NON-CONSTANT REDUCED-COMPLEXITY AND SHARED MULTIPLICATION submitted as a separate application by Charles D. Murphy. As of the mailing date of the present application, the first and second related applications have been submitted. As of the mailing date of the present application, the third related application has not yet been submitted.

### STATEMENT REGARDING FEDERALLY SPONSORED RESEARCH OR DEVELOPMENT

Not applicable

### REFERENCE TO A MICROFICHE APPENDIX

Not applicable

### BACKGROUND

1. Field of Invention

The invention relates to number transforms used in signal processing, specifically to computing products of numbers and weights using multiplication techniques which accommodate numbers that can have differing finite-precision numeric formats, with the multiplication techniques tailored to the special properties of each finite-precision numeric format.

2. Description of Prior Art

Signal processing involves manipulation of one or more input signals in order to produce one or more output signals. In digital signal processing, the signals are represented by numbers. The numbers have number values and also have number representations in particular finite-precision numeric formats. A finite-precision numeric format is typically defined by a given number of representation elements of a particular type, such as bits or digits, and by a mapping between number values and representation element values. Some common types of finite-precision numeric formats are finite-precision binary twos complement, signed integer, unsigned integer, and floating point, among others.

Arithmetic operations are basic tools of digital signal processing. Two of the most important arithmetic operations are multiplication and addition. These two operations can be used to implement a wide variety of mathematical functions. However, they are particularly important in the class of signal processing transforms that compute sums of products.

Well-known examples of transforms that compute sums of products are discrete Fourier transforms, discrete cosine transforms, discrete sine transforms, and the corresponding inverse transforms of each. Typically, these transforms accept a set of input numbers, multiply the input numbers by a set of weights, and add the resulting products to produce a set of output numbers. In these transforms, addition and multiplication operations are used repeatedly, and sometimes exclusively.

In a practical signal processing system, it is desired that a signal processing transform have low cost. Cost can be measured in terms of economic cost, chip space, processor cycles, speed, power consumption, or other resources. For transforms that rely heavily on multiplication and addition operations, the cost of computing the transform may depend on the number of operations and on the cost of each operation. To reduce the overall cost, a design may attempt to reduce the number of operations, to reduce the cost of operations, or both.

In several important technologies, including application-specific integrated circuits, field-programmable gate arrays, and software for general purpose microprocessors, the cost of a multiplication operation is much higher than that of an addition operation. In these technologies, the cost of multiplication operations may dominate the overall cost of computing a signal processing transform.

A general multiplier is a circuit or sequence of operations that is able to compute the product of two numbers. Each number is represented in a particular finite-precision numeric format. The general multiplier must accommodate all possible numbers permitted by each finite-precision numeric format. This makes the general multiplier very flexible. It can be used for many product computations in a given signal processing transform, and the circuitry or sequence of operations can be duplicated without any extra design effort. On the other hand, a general multiplier may have a very high cost as measured by power consumption, chip space, or other resource.

A constant multiplier is capable of multiplying a number by a constant. The number can take on any value permitted by its finite-precision numeric format. A constant multiplier is very inflexible. It can only be re-used when one of the numbers being multiplied is equal to the constant. However, a constant multiplier design can exploit properties of the representations of the number and the constant to greatly reduce the cost of the multiplication operation relative to that of a general multiplier.

Constant multipliers are particularly useful in signal processing transforms that require large numbers of multiplications by known, fixed numbers. The discrete Fourier, cosine, sine, and their inverse transforms mentioned above are examples of such transforms. These transforms compute sums of weighted inputs. The weights are known, fixed numbers. Whether in direct form or using fast computation techniques, constant multipliers can replace general multipliers in these transforms, resulting in reduced cost.

Constant multipliers and techniques for designing constant multipliers appear in U.S. Pat. No. 6,223,197 (issued to K. Kosugi on Apr. 24, 2001), in U.S. Pat. No. 5,903,470 (issued to A. Miyoshi and T. Nishiyama on May 11, 1999), in U.S. Pat. No. 5,841,684 (issued to K. Dockser on Nov. 24, 1998), in U.S. Pat. No. 5,815,422 (issued to K. Dockser on Sep. 29, 1998), in U.S. Pat. 5,600,569 (issued to T. Nishiyama and S. Tsubata on Feb. 4, 1997) and in U.S. Pat. No. 5,159,567 (issued to J. Gobert on Oct. 27, 1992).

The patent application NON-CONSTANT REDUCED-COMPLEXITY MULTIPLICATION IN SIGNAL PROCESSING TRANSFORMS having U.S. application Ser. No. 09/963,623 and filing date Sep. 27, 2001 proposed non-constant, non-general multipliers. Implementations of these non-constant, non-general multipliers exploit restrictions on one or both of the numbers being multiplied to enable lower cost than a general multiplier and greater flexibility than a constant multiplier. A requirement of the non-general, non-constant multiplier is that one of the numbers being multiplied can take on more than one value but cannot take on every value allowed by the number's finite-precision numeric format. As a simple example, a number could be allowed to take on 10 values out of a total of 32 possible values supported by a 5-bit binary format. The number is not a constant, but there may be common properties of the representations of the 10 values in the 5-bit binary format that enable reduced-cost multiplication.

In the general multipliers, constant multipliers, and non-constant, non-general multipliers of prior art, it is assumed that each of the two numbers being multiplied has a finite-precision numeric format. Prior art multipliers can exploit the properties of each format, such as low-cost negation via bit-flipping or bit-flipping and addition and low-cost multiplication via shifting. Prior art multipliers can also exploit the properties of the allowed number values and their representations, such as a number being a constant or otherwise restricted.

It is possible to express a number value in a variety of different finite-precision numeric formats. The numeric formats can be structurally different, such as twos-complement binary formats and signed binary formats. Alternatively, the numeric formats can be structurally similar, such as a 24-bit twos complement binary format and a 16-bit twos complement binary format. The representation of one number value in a particular finite-precision numeric format may or may not be similar to the representation of another number value in the same or in a different finite-precision numeric format. Special properties of relationships between representations of numbers depend on number values and on finite-precision numeric formats. On the other hand, special properties of relationships between number values do not depend on the details of finite-precision numeric formats.

A multiplier for one representation of a number can have a different cost than a multiplier that uses a different representation. Also, a multiplier for one representation of a number or for one finite-precision numeric format may use calculations similar to those of a multiplier for the representation of another number or for another finite-precision numeric format. These similarities in calculation may reflect special relationships between representations of numbers, between number values, or both.

Prior art multipliers do not consider the cost of a particular representation of a particular number value except when the number value is a constant. Prior art non-constant multipliers typically have a single finite-precision numeric format for each multiplier input, with each finite-precision numeric format defining a set of allowed number values. Even prior art constant multipliers, which attempt to exploit the restriction of one number being constant, typically assume a single finite-precision numeric format for the non-constant number being multiplied.

Signal processing transforms such as discrete Fourier transforms, inverse discrete Fourier transforms, and other transforms that compute sums of products are widely used in areas such as digital communications and sonar, radar, speech, image, biomedical, and video signal processing. Whether or not a particular transform is or is not practical depends in large part on the economic cost of building a device to compute the transform and on technological limitations. Many transforms rely heavily on the basic operation of multiplication for signal manipulation. Techniques for low-complexity multiplication and for reducing the number of required multiplication operations are useful in enabling practical signal processing systems.

The disadvantages of prior art multipliers used in signal processing transforms are the following:

a. A general multiplier capable of computing any of the desired products in a signal processing transform may be very costly to implement, particularly in technologies such as application-specific integrated circuits, field-programmable gate arrays, and general purpose microprocessors.

b. A constant multiplier which can compute any desired product in which one number is a particular product and the other number can take on any value permitted by a particular finite-precision numeric format may have very low individual cost, but also has very low flexibility.

c. Prior art non-constant, non-general multipliers have greater flexibility and cost than constant multipliers, and at the same time have lower flexibility and cost than general multipliers, yet compute products based on restrictions on allowed numbers in single finite-precision numeric formats.

d. Prior art multipliers do not exploit the fact that a number value can be represented in different formats and that multipliers using different representations of a number value can have different costs.

e. Prior art multipliers do not exploit the fact that calculations using representations in different finite-precision numeric formats may have many features in common.

### SUMMARY

The present invention is a technique for multiplying two numbers in which one or both of the numbers may be represented in more than one finite-precision numeric format, where the technique exploits properties of the differing representations and formats to obtain reduced implementation cost.

Objects and Advantages

Accordingly, several objects and advantages of the present invention are that:

a. Using said invention, multipliers can exploit common properties of multiplication in differing finite-precision numeric formats, resulting in reduced multiplier implementation cost.

b. Using said invention, multipliers can exploit common properties of groups of number values in differing finite-precision numeric formats, resulting in reduced multiplier implementation cost.

c. Said invention can be replace prior art general multipliers, constant multipliers, non-constant, non-general multipliers, or combinations of such multipliers, resulting in reduced multiplier implementation cost.

d. Said invention can be applied to signal processing transforms with fixed, known weights, such as discrete Fourier transforms, discrete cosine transforms, discrete sine transforms, and inverse transforms corresponding to each of these, resulting in reduced computational cost.

e. Said invention can be applied to fast transform techniques such as fast Fourier transforms, fast cosine transforms, fast sine transforms, and fast inverse transforms corresponding to each of these, resulting in reduced computational cost.

f. Said invention can exploit properties of finite-precision numeric representations of numbers and properties of finite-precision numeric formats, as well as properties that depend on number values and not on particular representations or particular formats.

Further objects and advantages of the invention will become apparent from a consideration of the drawings and ensuing description.

### DRAWING FIGURES

In the drawings, closely related figures have the same number but different alphabetic suffixes.

FIG. 1A shows the 8-bit twos complement representations of sin(2π/N) and sin(4π/N) for N=64.

FIG. 1B shows the 16-bit twos complement representations of sin(2π/N) and sin(4π/N) for N=64.

### REFERENCE NUMERALS IN DRAWINGS

34 a fifth of bit of sin(2π/64)

36 a sixth bit of sin(2π/64)

38 a fourth bit of sin(4π/64)

40 a fifth bit of sin(4π/64)

42 an 8-bit floating point value of sin(2π/64)

44 an 8-bit floating point value of sin(4π/64)

46 a desired value of sin(2π/64)

48 a desired value of sin(4π/64)

50 a fifteenth bit of sin(2π/64)

52 a sixteenth bit of sin(2π/64)

54 a ninth bit of sin(4π/64)

56 a tenth bit of sin(4π/64)

58 an eleventh bit of sin(4π/64)

60 a twelfth bit of sin(4π/64)

62 a 16-bit floating point value of sin(2π/64)

64 a 16-bit floating point value of sin(2π/64)

Description—Signal Processing Transforms

Signal processing is widely used in such areas as digital communications, radar, sonar, astronomy, geology, control systems, image processing, and video processing. In digital signal processing, the signals are represented by numbers. Input signals or numbers are manipulated by signal processing transforms to produce output signals or numbers. The input numbers, the output numbers, and intermediate terms are represented in finite-precision numeric formats. Each format is defined by a finite number of representation elements and by a mapping between number values and representation element values.

Arithmetic operations are important tools in digital signal processing, particularly the operations of multiplication and addition. A general multiplier is a circuit or sequence of operations that computes the product of two numbers, each of which can have any value allowed by its numeric format. General multipliers are useful because they have standard circuitry or operations sequences that can be copied or reused. General multipliers are flexible, but may have a relatively high implementation cost.

The high cost of general multipliers is a particular impediment in technologies such as application-specific integrated circuits, field-programmable gate arrays, and general purpose microprocessors. In these technologies, the cost of a multiplication operation is much higher than the cost of an addition operation. The overall cost of computing a signal processing transform in these technologies may be dominated by the cost of the multiplication operations. Thus it is useful to reduce the number of multiplication operations required or the cost of the multiplication operations.

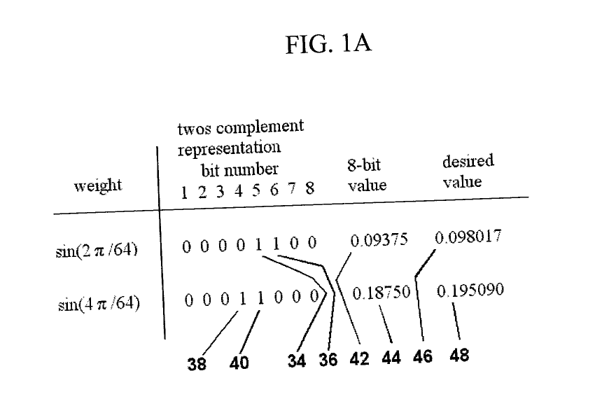

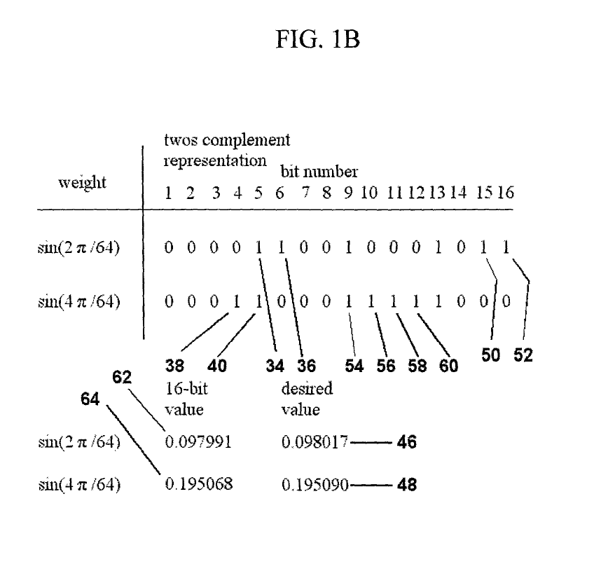

Description—FIG. 1A

In digital signal processing, each number is actually a representation of a number value in a particular finite-precision numeric format. While it is possible to have multiple types of representation elements in a finite-precision numeric format, it is common to use binary representation elements, or bits, which can take on two possible values. Common mappings with binary representation elements include signed integer, unsigned integer, floating point, and twos complement.

FIG. 1A shows the 8-bit twos complement representation of sin(2π/64) and sin(4π/64), two numbers which are possible weights used in computing a discrete Fourier transform. The only non-zero bits in the 8-bit twos complement representation of sin(2π/64) are a fifth bit of sin(2π/64) 34 and a sixth bit of sin(2π/64) 36. The only non-zero bits in the 8-bit twos complement representation of sin(4π/64) are a fourth bit of sin(4π/64) 38 and a fifth bit of sin(4π/64) 40.

An 8-bit floating-point value of sin(2π/64) 42 according to the representation is 0.09375, while a desired value of sin(2π/64) 46 is 0.098017 to six decimal places. An 8-bit floating point value of sin(4π/64) 44 according to the representation is 0.18750, while a desired value of sin(4π/64) 48 is 0.195090 to six decimal places.

The difference between the floating point values and the desired values in FIG. 1A demonstrates the finite-precision nature of the numeric formats. A representation of a desired number value approximates the number value in most cases. When referring to manipulation of numbers, for instance, to multiplication, number representations are the inputs and number representations are outputs. Processing of the representations approximates the same processing of the desired number values.

Description—FIG. 1B

With greater precision, the floating point values may become closer to the desired values. FIG. 1B shows the 16-bit twos complement representations of sin(2π/64) and sin(4π/64). There are six non-zero bits in the 16-bit twos complement representation of sin(2π/64), including a fifth bit of sin(2π/64) 34, a sixth bit of sin(2π/64) 36, a fifteenth bit of sin(2π/64) 50, and a sixteenth bit of sin(2π/64) 52. There are seven non-zero bits in the 16-bit twos complement representation of sin(4π/64). Among these are a fourth bit of sin(4π/64) 38, a fifth bit of sin(4π/64) 40, a ninth bit of sin(4π/64) 54, a tenth bit of sin(4π/64) 56, an eleventh bit of sin(4π/64) 58, and a twelfth bit of sin(4π/64) 60.

The 16-bit floating-point value of sin(2π/64) 62 is 0.097991 to six decimal places. The desired decimal value of sin(2π/64) 46 is 0.098017. The 16-bit floating-point value of sin(4π/64) 64 is 0.195068 to six decimal places. The desired value of sin(4π/64) 48 is 0.195090 to six decimal places. With more bits, or higher precision, the actual value more closely matches the desired value. However, this is not necessarily the case for all number values. Description—Multiplication Cost

FIG. 1A and FIG. 1B show that a number value such as sin(2π/64) or sin(4π/64) can have differing representations. A multiplication operation requires manipulation of the representation element values according to a prescribed set of rules. Since there are only 8 representation elements in an 8-bit twos complement format as opposed to 16 representation elements in a 16-bit twos complement format, a general multiplier for the representations of FIG. 1A has lower cost than a general multiplier for the representations of FIG. 1B. Likewise, a constant multiplier for one of the number representations in FIG. 1A has lower cost than a constant multiplier for the corresponding representation in FIG. 1B. The former constant multiplier does not have to take into account the additional bits in the higher-precision representation.

The patent application NON-CONSTANT REDUCED-COMPLEXITY MULTIPLICATION IN SIGNAL PROCESSING TRANSFORMS having U.S. application Ser. No. 09/963,623 and filing date Sep. 27, 2001 proposed non-constant, non-general multipliers. The general goal of such multipliers is to exploit special properties of groups of representations to achieve a multiplier with greater flexibility than constant multipliers at lower cost than general multipliers.

As an example of special properties of groups of representations, consider the two number representations in FIG. 1A. The representations are members of a first input set of all 8-bit twos complement representations having exactly two non-zero bits. The representations are also members of a second input set of all 8-bit twos complement representations having exactly two non-zero bits, with the two bits adjacent to one another. The representations are also members of a third input set of all 8-bit twos complement representations having exactly two non-zero bits, which are adjacent to one another and one of which is bit number 5.

Clearly, the three input sets are not identical. It is possible to make a non-general multiplier for the second input set which has lower cost than a non-general multiplier for the first input set because the former multiplier does not have to take into account representations which have exactly two non-zero bits but in which the two non-zero bits are not adjacent. Similarly, it is possible to make a non-general multiplier for the third input set which has lower cost than a non-general multiplier for the second input set.

Non-general multipliers for each of the three input sets can accept as inputs either of the representations in FIG. 1A. The cost of a particular implementation of a non-constant, non-general multiplier depends on the desired set of number representations which it can accept as input and on the interpretation of the structures of the representations.

The patent application NON-CONSTANT REDUCED-COMPLEXITY MULTIPLICATION IN SIGNAL PROCESSING TRANSFORMS proposed exploiting restrictions on groups of allowed numbers at one or both multiplier inputs to achieve multiplier cost savings. However, in the example just above with first input, second input, and third input sets, it becomes clear that there can be many interpretations of the common properties of a group of numbers. Furthermore, it is possible to divide a group of desired number representations into two or more sub-groups, each of which has its own common properties. It is possible that exploiting common properties of separate sub-groups can lead to lower-cost multipliers than exploiting common properties of a single larger group. This observation leads to the present invention. Description—the Preferred Embodiment of Claim 1

The preferred embodiment of the invention described in claim 1 is a machine for computing a first product of two numbers. The preferred embodiment includes a first multiplier input, a second multiplier input, and combined multiplier means for computing the first product. The first multiplier input is a first real number which can be a member of a first set of representations in a first finite-precision numeric format and which can also be a member of a second set of representations in a second finite-precision numeric format. The second multiplier input is a second real number which can be a member of third set of representations in a third finite-precision numeric format and which can also be a member of a fourth set of representations in a fourth finite-precision numeric format. The first, second, third, and fourth sets of representations have corresponding first, second, third, and fourth sets of number values.

The third set of representations in the third finite-precision numeric format and the fourth set of representations in the fourth finite-precision numeric format each have at least one member. Thus, the second multiplier input can have representations in more than one finite-precision numeric format.

The combined multiplier means of claim 1 includes first multiplier means and second multiplier means. The combined multiplier means uses the first multiplier means to compute the first product when the second multiplier input has a representation from the third set of representations in the third finite-precision numeric format. The combined multiplier means uses the second multiplier means to compute the first product when the second multiplier input has a representation from the fourth set of representations in the fourth finite-precision numeric format.

An important limitation is that the combined multiplier means cannot use the first multiplier means to compute the first product when the second multiplier input does not have a representation from the third set of representations in the third finite-precision numeric format and a corresponding value from the third set of number values. The combined multiplier means should use the first multiplier means when the second multiplier input has a representation from the third set of representations and a corresponding value from the third set of number values, and should use the second multiplier means when the second multiplier input has a representation from the fourth set of representations and a corresponding value from the fourth set of number values.

In other words, the preferred embodiment of the invention is a machine that can multiply a first real number by a second real number that can be represented in two different finite-precision numeric formats. The capabilities of parts of the machine are limited in certain ways.

Returning to the discussion above on exploiting the common properties of groups of desired input numbers, the preferred embodiment of the invention can exploit common properties of sub-groups of desired input numbers. For example, a specific implementation of the preferred embodiment might be a multiplier that can compute the product of a first number and a second number when the second number is a member of the second input set or one of the two 16-bit twos complement number representations of FIG. 1B.

The second input set described above is the set of all 8-bit twos-complement number representations having exactly two non-zero bits with the two non-zero bits adjacent to each other. The specific implementation may exploit the common properties of the seven members of the second input set while including separate circuitry or operations for the two 16-bit twos complement inputs that are allowed. Alternatively, the specific implementation may exploit the common properties of the nine allowed representations according to different sub-group membership.

The term “finite-precision numeric format” is usually associated with a well-known mapping such as twos complement, signed integer, unsigned integer, or floating point. An 8-bit twos complement format is not the same as an 8-bit signed integer format. Also, an 8-bit twos complement format is not the same as a 16-bit twos complement format. It is intended that in the claims of the present invention “finite-precision numeric format” also include restrictions such as particular representation element values or particular relations among representation elements. Thus, the set of 8-bit twos complement representations with exactly two non-zero bits defines a finite-precision numeric format that is not the same format defined by the set of all 8-bit twos complement representations.

The present invention is intended to cover real number multipliers that can accept a second multiplier input which can have representations in more than one finite-precision numeric format. By expanding the definition of finite-precision numeric format to include alternative sets such as subsets of representations in existing finite-precision numeric formats, it is easy to consider various groups or sub-groups of representations having different formats with various common features. Then a combined multiplier can be implemented with two or more parts each of which is an efficient multiplier for one of the groups or sub-groups. The overall cost of implementing the combined multiplier may be less than the overall cost of implementing a multiplier which does not separate the allowed number representations into different groups.

Description—Claim 2

Claim 2 is a dependent machine claim that further restricts the combined multiplier means of claim 1. The combined multiplier means cannot compute the first product using the second multiplier means when the second multiplier input does not have a representation in the fourth set of representations and a corresponding number value in the fourth set of number values.

Dependent machine claim 2 emphasizes that the combined multiplier means can be made up of separate multipliers for each of the distinct sets of representations allowed for the second multiplier input. A second multiplier means that is not able to accommodate a second multiplier input from the third set of representations may have lower complexity than a second multiplier means that must be able to accommodate a second multiplier input from the third set of representations.

Description—Claim 3 and Claim 4

Dependent machine claim 3 limits the allowed representations and values of the first multiplier input of claim 1. In particular, the first multiplier input may only be represented in the first finite-precision numeric format. Claim 3 requires that the first set of representations in the first finite-precision numeric format have at least one member.

If the first set of representations has exactly one member, then the combined multiplier means form a constant multiplier which accommodates the second multiplier input having representations in more than one finite-precision numeric format. If the first set of representations has more than one member, but not every representation in the first finite-precision numeric format, then the combined multiplier means form a non-general, non-constant multiplier which accommodates the second multiplier input having representations in more than one finite-precision numeric format.

Dependent machine claim 3 is intended to cover embodiments of the invention that implement constant multipliers or the non-general, non-constant multipliers of the patent application NON-CONSTANT REDUCED-COMPLEXITY MULTIPLICATION IN SIGNAL PROCESSING TRANSFORMS. With the present invention, such embodiments may have lower cost than prior art constant or non-general, non-constant multipliers.

Dependent machine claim 4 requires that the first set of representations, the first set of number values, the second set of representations, and the second set of number values in claim 1 each have at least one member. Moreover, the first finite-precision numeric format is not the same as the second finite-precision numeric format.

The embodiment of the invention described in claim 4 is a multiplier that can accept a first multiplier input having representations in more than one finite-precision numeric format as well as a second multiplier input having representations in more than one finite-precision numeric format.

Description—Claim 5 Through Claim 8

Dependent machine claim 5 requires that the first set of representations of claim 1 contain all representations in the first finite-precision numeric format and also requires that the first set of number values contain all number values supported by the first finite-precision numeric format. Thus, the combined multiplier means can accept as a first multiplier input any number represented in the first finite-precision numeric format.

Dependent machine claim 6 requires that the first set of representations of claim 1 contain at least one member but not every representation in the first finite-precision numeric format. Also, the first set of number values has at least one member but does not contain every number value supported by the first finite-precision numeric format.

Like dependent machine claim 3, dependent machine claim 6 is intended to cover embodiments of the invention that implement constant multipliers or the non-general, non-constant multipliers of the patent application NON-CONSTANT REDUCED-COMPLEXITY MULTIPLICATION IN SIGNAL PROCESSING TRANSFORMS.

Dependent machine claim 7 requires that the third set of representations of claim 1 contain all possible representations in the third finite-precision numeric format and that the third set of number values of claim 1 contain all number values supported by the third finite-precision numeric format. The embodiment of the invention described in claim 7 includes is able to accept any representation in the third finite-precision numeric format as a second multiplier input. This embodiment may reflect a very narrow definition for the third finite-precision numeric format and a corresponding low-cost first multiplier means. Alternatively, this embodiment may reflect combined multiplier means including first multiplier means that can accept a particular number value represented in the third finite-precision numeric format, but for which second multiplier means and a representation in the fourth finite-precision numeric format have lower implementation cost for that particular number value.

Dependent machine claim 8 restricts claim 1 by requiring that the third set of representations not include all representations in the third finite-precision numeric format and by requiring that the third set of number values not include all number values supported by the third finite-precision numeric format. Embodiments of the invention according to claim 8 can accept as the second multiplier input representations in more than one finite-precision numeric format, but not every possible representation allowed by one of the formats.

Description—Claim 9 and Claim 10

Dependent machine claim 9 requires that the first and second sets of representations and the first and second sets of number values in claim 1 each have at least one member. Also, the first and second set of number values are required to have no common members.

Embodiments of the invention according to claim 9 can accept a first multiplier input represented in the first finite-precision numeric format or represented in the second finite-precision numeric format. However, the number values for which representations in the first finite-precision numeric output are acceptable cannot be represented in the second finite-precision numeric format Likewise, the number values for which representations in the second finite-precision numeric format are acceptable cannot be represented in the first finite-precision numeric format.

It is intended that claim 9 cover multipliers in which particular number values for the first multiplier input require particular finite-precision numeric formats. For these values there are no equivalent representations that may be passed to the combined multiplier in order to compute the desired product.

For example, in digital communications, the representations of a small number of the allowed symbol values may share common properties that the representations of the other allowed symbol values do not have. For instance, they might require 16-bit precision whereas the representations of the other allowed symbol values may only require 8-bit precision. For one set of symbol values, the first multiplier input must have representations with 16-bit precision, while for another set of symbol values, the first multiplier input must have representations with 8-bit precision.

Dependent machine claim 10 restricts machine claim 1 to having a third set of number values and a fourth set of number values that do not have any common members. Thus for particular number values of the second multiplier input, particular representation formats may be required.

Description—Method Claims 11 and 12

Claim 11 is an independent method claim analogous to machine claim 1. Instead of covering apparatus for a multiplier that can accommodate one or both inputs having representations in more than one finite-precision numeric format, it is intended to cover methods for multiplication that can accommodate one or both inputs having representations in more than one finite-precision numeric format.

The method of claim 11 includes multiplication of a first multiplication input by a second multiplication input to produce a first product. The first multiplication input is a real number which can be a member of a first set of representations in a first finite-precision numeric format or which can be a member of a second set of representations in a second finite-precision numeric format. The second multiplication input is a real number which can be a member of a third set of representations in a third finite-precision numeric format or which can be a member of a fourth set of representations in a fourth finite-precision numeric format. Corresponding to each set of representations is a set of number values. The third set of representations and the fourth set of representations must each have at least one member, and the third finite-precision numeric format is not the same as the fourth finite-precision numeric format.

Claim 11 includes combined multiplication, with a first multiplication method used for computing the first product when the second real number has a representation from the third set of representations and a corresponding number value from the third set of number values and with a second multiplication used for computing the first product when the second real number has a representation from the fourth set of representations and a corresponding number value from the fourth set of number values.

As a limitation, the method of the combined multiplication cannot use the first multiplication method to compute the first product when the second real number does not have both a representation from the third set of representations and a corresponding number value from the third set of number values. For instance, the first multiplication method cannot compute the first product when the second multiplication input is a member of the fourth set of representations.

A possible advantage of the method of the combined multiplication is that its implementation with the first multiplication method and the second multiplication method may be less costly than a single multiplication method which must be able to account for the second multiplication input having representations in the third or the fourth finite-precision numeric formats.

Dependent method claim 12 includes the further restriction that the method of the combined multiplication cannot use the second multiplication method to compute the first product when the second real number has a representation and a corresponding value that are not members of the fourth set of representations and the fourth set of number values respectively.

Description—Claim 13 and Claim 14

Dependent method claim 13 restricts claim 11 by requiring that the first multiplication input only be represented in the first finite-precision numeric format. The first set of representations can have exactly one member, all possible representations in the first finite-precision numeric format, or some number of members in between. Thus the method of the multiplication can result in constant multiplication, general multiplication for numbers in the first finite-precision numeric format, or non-constant, non-general multiplication. Methods that are embodiments of the present invention may have lower implementation cost than prior art methods.

Dependent method claim 14 restricts claim 11 to having first and second sets of representations and number values each of which have at least one member. Also, the first finite-precision numeric format is not the same as the second finite-precision numeric format. The method of claim 14 must be able to accommodate having for both the first multiplication input and the second multiplication input representations in more than one finite-precision numeric format.

Description—Claim 15 Through Claim 18

Dependent method claim 15 requires that the first set of number values contain all number values supported by the first finite-precision numeric format and that the first set of representations contain all possible representations in the first finite-precision numeric format. Thus the method of claim 15 for the combined multiplication is a general multiplication method for the first multiplication input and the first finite-precision numeric format.

Dependent method claim 16 requires that the first set of number values have at least one member but not all number values supported by the first finite-precision numeric format, and that the first set of representations have at least one member but not all possible representations in the first finite-precision numeric format. Thus, the method of claim 16 is for combined multiplication that is not general for the first multiplication input in the first finite-precision numeric format.

Dependent method claim 17 requires that the third set of representations contain all possible representations in the third finite-precision numeric format, and that the third set of number values contain all number values supported by the third finite-precision numeric format. An embodiment of the invention according to claim 17 has a method for combined multiplication in which the first multiplication method is general for the second multiplication input represented in the third finite-precision numeric format. However, it may be the case that the second multiplication method may have lower implementation cost for some number values common to both the third set of number values and the fourth set of number values.

Dependent method claim 18 requires that the third set of representations not contain all representations in the third finite-precision numeric format, and that the third set of number values not contain all possible values supported by the third finite-precision numeric format. This means that some representations in the third finite-precision numeric format cannot be accepted as the second multiplication input. If it is desired to be able to use the corresponding number values, they may be represented in the fourth finite-precision numeric format so that they may be accommodated by the second multiplication method.

Description—Claim 19 and Claim 20

Dependent method claim 19 has first and second sets of representations and number values each of which has at least one member. However, the first set of number values and the second set of number values cannot have any common members. This means that the method of the combined multiplication cannot use the first multiplication method for any number values in the second set of number values.

Dependent method claim 20 restricts method claim 11 by requiring that the third set of number values and the fourth set of number values have no common members. The method of the combined multiplication cannot use the first multiplication method for number values in the second set of number values. Instead, the combined method should use the second multiplication method for these values. Description—More on Finite-Precision Numeric Formats

Throughout the present application there has been discussion of “finite-precision numeric formats” in which numbers are represented in digital signal processing. In prior art digital calculation, a computation machine or method usually has digital inputs with a well-defined structure of representation element order and mapping. By manipulating the values of the representation elements, for instance by shifting or by logical operations, it is possible to implement desired mathematical operations such as multiplication. The element value operations that implement the mathematical operations depend a great deal on the finite-precision numeric formats being used.

The non-general, non-constant multipliers of the patent application NON-CONSTANT REDUCED-COMPLEXITY MULTIPLICATION IN SIGNAL PROCESSING TRANSFORMS are presented in terms of a single finite-precision numeric format for each multiplier input, with the goal of introducing a broad range of multipliers between the constant and general multipliers of prior art in terms of both flexibility and implementation cost. However, during preparation of the application, it was realized that a finite-precision numeric format is simply a way of defining a relationship between a set of number values and a set of physical states in a digital computing device. One can describe the relationship in many ways.

The present invention is an attempt to capture the notion of a composite relationship between number values and physical states in a digital computing device. That is, there may be one finite-precision numeric format which describes the mapping between a set of number values and a set of physical states in a simple manner. Also, there may be a second finite-precision numeric format describes the mapping between another set of number values and another set of physical states in a simple manner. The two finite-precision numeric formats may together provide a simpler description than that of a single all-encompassing finite-precision numeric format.

Similarly, an operation such as multiplication is a relationship between input number representations and output number representations. A single all-encompassing description of how to multiply may result in multiplier implementations with high cost. Having two—or more than two—descriptions, each of how to multiply members of certain sets of number representations, may result in implementations with lower cost.

In multiplication, the potential cost reductions are particularly appealing when the multiplier inputs are from a very small subset of the set of all possible representations in a particular finite-precision numeric format. For instance, a 512-point discrete Fourier transform has 128 unique real number values and their negatives as components of complex weights. If the components are represented in a 16-bit twos complement format, only 256 of 65536 possible number representations are used. A multiplier exploiting properties of the 256 allowed representations as a group or in sub-groups can have lower cost than a multiplier which can accommodate all 65536 possible number representations.

More generally, in signal processing applications such as digital filtering, number values for multiplication are selected to meet design criteria such as amplitude and phase gain, time delay, or stability. The desired number values are represented and manipulated digitally. When the desired number values are few relative to the number of possible representations, it is useful to design multipliers that exploit common features of subsets of the desired representations.

In the claims, embodiments of the invention are defined by the sets of allowed input representations and number values, by the capabilities of multipliers or multiplication methods, and by choice of multiplier or multiplication method depending on the inputs. The capabilities of the multipliers and multiplication methods are stated in terms of which products they can compute and also in terms of which products they cannot compute. The latter terms, though negative, are important to distinguish the present invention from prior art.

For instance, a prior art general multiplier multiplying 16-bit twos complement representations could also be viewed as multiplying numbers in a first finite-precision numeric format that consists of all 16-bit twos complement representations which have exactly one non-zero bit and also numbers in a second finite-precision numeric format that consists of all 16-bit twos complement representations which do not have exactly one non-zero bit. Since the same multiplication technique is used for representations in both formats, the prior art general multiplier is not covered by the claims of the present invention.

With respect to choice of multiplier or multiplication method, it is possible to interpret “finite-precision numeric format” in such a way that a representation may be in more than one finite-precision numeric format, for instance, in a third finite-precision numeric format and in a fourth finite-precision numeric format.

As an example, the 8-bit twos complement representation of sin(2π/64) in FIG. 1A is a valid representation in the set of all 8-bit twos complement representations having exactly two non-zero bits and is also a valid representation in the set of all 8-bit twos complement representations having bit 5 and bit 6 equal to 1. Since the invention uses a first multiplier or multiplication method when the second multiplier input or multiplication input is in a third finite-precision numeric format and a second, different multiplier or multiplication method when the second multiplier input or multiplication input is in a fourth finite-precision numeric format, each format should be defined or interpreted in such a way that their members do not cause conflict in the function of the combined multiplier or multiplication method.

In other words, a finite-precision numeric format is defined in part by a set of number representations. It is possible to create a different finite-precision numeric format by changing the membership of this set. When judging whether or not a particular implementation is or is not an embodiment of the present invention, there should be reasonable flexibility in defining finite-precision numeric formats. An arbitrary implementation that is structurally identical to an embodiment of the invention should not be considered different merely because a finite-precision numeric format or a set is defined in such a way as to avoid the language of the claims.

### CONCLUSION, RAMIFICATIONS, AND SCOPE

The reader will see that the present invention has several advantages over prior art techniques for multiplying one number by another, particularly in signal processing transforms that use sums of products. The products calculated for these transforms often have input numbers that take on values and representations from a very small subset of the set of all possible values and representations supported by a particular finite-precision numeric format. The present invention is able to exploit restrictions on the relationships between members of groups of allowed number values and allowed representations to achieve reduced-cost implementations of multiplication operations.

The present invention can be viewed as multiplication with novel definitions of finite-precision numeric formats and as multiplication with more than one finite-precision numeric format. Novel definitions of finite-precision numeric formats can include specific restrictions that define relatively small sets of number values and representations from existing finite-precision numeric formats and can include restrictions that define groups of numbers according to common properties not considered in the prior art. It is then possible that a multiplier or a multiplication method tailored to the restrictions of the small sets or groups can have lower implementation cost than a multiplier or multiplication method for larger sets or larger groups. If there is a desired larger set of number values and representations, having more than one finite-precision numeric format allowed for an input permits multipliers or multiplication methods that exploit common properties of small subsets of the desired larger set. A combined multiplier or multiplication method with parts tailored to the subsets may have lower implementation cost than a single multiplier or multiplication method for the desired larger set.

In a preferred embodiment of the invention, a combined multiplier computes a first product which is the multiplier output using first multiplier means when one multiplier input is from a third set of representations in a third finite-precision numeric format. When that multiplier input is a member of a fourth set of representations in a fourth finite-precision numeric format, the combined multiplier computes the first product using second multiplier means. The first multiplier means cannot be used to compute the first product when the multiplier input is not represented in the third finite-precision numeric format. The limit on the capability of the first multiplier means serves to differentiate the preferred embodiment from alternative interpretations of prior art multipliers, and also to emphasize that the preferred embodiment is intended to result in efficient, low-cost implementation of the component multiplier means and the overall combined multiplier.

In an alternative embodiment of the invention, the second multiplier means cannot compute the first product when the multiplier input is not from the fourth set of representations in the fourth finite-precision numeric format. Thus the first multiplier means is tailored to the third set of representations and the second multiplier means is tailored to the fourth set of representations.

Other embodiments of the invention might include combined multiplier means made up of three or more component multiplier means. Each component multiplier means could have differing capabilities. Depending on the definitions of each set for which each component multiplier means can compute the first product, differing multiplier structures with differing implementation costs could be used, resulting in various overall structures and costs for the combined multiplier means. The goal, of course, is low overall cost for the combined multiplier means.

In an alternative embodiment of the invention, one multiplier input may take on any value and representation in a particular finite-precision numeric format, while the other input is permitted to have representations in more than one finite-precision numeric format. In an alternative embodiment of the invention, one multiplier input may take on a strict subset of the values and representations in a particular finite-precision numeric format, while the other input is permitted to have representations in more than one finite-precision numeric format. In an alternative embodiment of the invention, both multiplier inputs may be permitted to take on values and representations in multiple formats.

Embodiments of the invention can emulate constant multipliers, general multipliers, and non-constant, non-general multipliers. Prior art constant, general, and non-constant, non-general multipliers treat each input as coming from a single large set of allowed inputs, with representations coming from prior art finite-precision numeric formats. Corresponding embodiments of the invention divide the large set of allowed inputs into smaller sets of allowed inputs, and exploit common features of the smaller sets. On a structural level, the implementations of embodiments of the present invention differ from implementations of prior art multipliers. The description of several component multipliers may be somewhat more complicated than that of a single multiplier with broad capabilities, but the resulting combined multiplier may require less chip space, fewer logic gates, less power, or fewer processor cycles than the single multiplier.

The invention is used in computing sums of products. It is particularly useful in signal processing transforms with fixed weights, especially when the transform is used repeatedly in a signal processing application. The invention can be used to multiply real numbers that are Cartesian components of complex numbers.

The invention can be used in computing discrete Fourier transforms, discrete cosine transforms, discrete sine transforms, inverse discrete Fourier transforms, inverse discrete cosine transforms, inverse discrete sine transforms, and other transforms. The invention can be used for digital filtering. The invention can be used for pulse-shaping in digital communications, or for digital modulation.

The invention is not limited to particular number representations or to particular applications. Signal processing transforms that compute multiple sums of products are used in digital communications, radar, sonar, astronomy, geology, control systems, image processing, and video processing. Technologies used to implement signal processing transforms include hardware technologies such as application specific integrated circuits and field-programmable gate arrays and software technologies such as multiplication on a general-purpose microprocessor.

The invention can be used as part of a circuit or software instruction sequence design library. The invention can be included as part of a computer program that automatically generates efficient machines and methods for hardware circuitry and software instruction sequences.

The description above contains many specific details relating to finite-precision numeric formats, representation elements, representation element values, number values, representations, implementation cost, particular transforms, hardware technologies, software technologies, and signal processing applications. These should not be construed as limiting the scope of the invention, but as illustrating some of the presently preferred embodiments of the invention. The scope of the invention should be determined by the appended claims and their legal equivalents, rather than by the examples given.

I claim:

1. A machine used in computing one or more sums of products, comprising:
a. as a first multiplier input, a first real number which can be a member of a first set of representations in a first finite-precision numeric format for a first set of number values and which can be a member of a second set of representations in a second finite-precision numeric format for a second set of number values
b. as a second multiplier input, a second real number which can be a member of a third set of representations in a third finite-precision numeric format for a third set of number values and which can be a member of a fourth set of representations in a fourth finite-precision numeric format for a fourth set of number values, where:
i. said third set of representations in said third finite-precision numeric format has at least one member
ii. said third set of number values has at least one member
iii. said fourth set of representations in said fourth finite-precision numeric format has at least one member
iv. said fourth set of number values has at least one member
v. said third finite-precision numeric format is not the same as said fourth finite-precision numeric format
c. combined multiplier means for computing a first product equal to the product of said first multiplier input and said second multiplier input, where:
i. said combined multiplier means includes first multiplier means for computing said first product when said second real number has a representation from said third set of representations in said third finite-precision numeric format and a corresponding number value from said third set of number values
ii. said combined multiplier means includes second multiplier means for computing said first product when said second real number has a representation from said fourth set of representations in said fourth finite-precision numeric format and a corresponding number value from said fourth set of number values
iii. said combined multiplier means cannot compute said first product using said first multiplier means when said second real number does not have both a representation from said third set of representations in said third finite-precision numeric format and a corresponding number value from said third set of number values
whereby said combined multiplier means can accommodate a number to be multiplied that may be represented in different finite-precision numeric formats, and whereby said first multiplier means and hence said combined multiplier means can be implemented with lower cost than if said first multiplier means must be able to accommodate all allowed representations and number values of said second multiplier input.

2. The machine of claim 1 in which said combined multiplier means cannot compute said first product using said second multiplier means when said second real number does not have both a representation from said fourth set of representations in said fourth finite-precision numeric format and a corresponding number value from said fourth set of number values, whereby said second multiplier means and hence said combined multiplier means can be implemented with lower cost than if said second multiplier means must be able to accommodate all allowed representations and number values of said second multiplier input.

3. The machine of claim 1 in which said first multiplier input may only be represented in said first finite-precision numeric format, where:
a. said first set of representations in said first finite-precision numeric format has at least one member
b. said first set of number values has at least one member
c. said second set of representations in said second finite-precision numeric format has no members
d. said second set of number values has no members
whereby said combined multiplier means computes the product of said first real number represented in said first finite-precision numeric format and said second real number, which can be represented in said third finite-precision numeric format or in said fourth finite-precision numeric format.

4. The machine of claim 1 wherein:
a. said first set of representations in said first finite-precision numeric format has at least one member
b. said first set of number values has at least one member
c. said second set of representations in said second finite-precision numeric format has at least one member
d. said second set of number values has at least one member
e. said first finite-precision numeric format is not the same as said second finite-precision numeric format
whereby said combined multiplier means can accommodate multiplication of said first real number which can have representations in two different finite-precision numeric formats by said second real number which can also have representations in two different finite-precision numeric formats.

5. The machine of claim 1 in which:
a. said first set of representations in said first finite-precision numeric format includes all possible representations in said first finite-precision numeric format
b. said first set of number values includes all possible number values supported by said first finite-precision numeric format whereby said combined multiplier means can accept as said first multiplier input any number represented in said first finite-precision numeric format.

6. The machine of claim 1 in which:
a. said first set of representations in said first finite-precision numeric format has at least one member but does not include all possible representations in said first finite-precision numeric format
b. said first set of number values has at least one member but does not include all possible values supported by said first finite-precision numeric format
whereby said combined multiplier means cannot accept as said first multiplier input all possible number representations in said first finite-precision numeric format.

7. The machine of claim 1 in which:
a. said third set of representations in said third finite-precision numeric format includes all possible representations in said third finite-precision numeric format
b. said third set of number values includes all possible values supported by said third finite-precision numeric format
whereby said combined multiplier means can accept as said second multiplier input any number represented in said third finite-precision numeric format, but where said combined multiplier means may have lower cost when computing said first product when said second real number is represented in said fourth finite-precision numeric format and rather than in said third finite-precision numeric format, with the cost savings resulting from using said second multiplier means rather than said first multiplier means.

8. The machine of claim 1 in which:
a. said third set of representations in said third finite-precision numeric format does not include all possible representations in said third finite-precision numeric format
b. said third set of number values does not include all possible values supported by said third finite-precision numeric format whereby said combined multiplier means cannot accept as said second multiplier input every possible number represented in said third finite-precision numeric format.

9. The machine of claim 1 in which:
a. said first set of representations in said first finite-precision numeric format has at least one member
b. said first set of number values has at least one member
c. said second set of representations in said second finite-precision numeric format has at least one member
d. said second set of number values has at least one member
e. said first set of number values and said second set of number values have no common members
whereby said combined multiplier means cannot accept said first multiplier input in said first finite-precision numeric format when said first multiplier input has a number value in said second set of number values and whereby said combined multiplier means cannot accept said first multiplier input in said second finite-precision numeric format when said first multiplier input has a number value in said first set of number values, so that said combined multiplier means must accommodate representations in at least two different finite-precision numeric formats for two different number values of said first multiplier input.

10. The machine of claim 1 in which said third set of number values and said fourth set of number values have no common members, whereby said combined multiplier means cannot accept said second multiplier input in said third finite-precision numeric format when said second multiplier input has a number value in said fourth set of number values and whereby said combined multiplier means cannot accept said second multiplier input in said fourth finite-precision numeric format when said second multiplier input has a number value in said third set of number values, so that said combined multiplier means must accommodate representations in at least two different finite-precision numeric formats for two different number values of said second multiplier input.

11. A method used in computing one or more sums of products, comprising combined multiplication of a first multiplication input by a second multiplication input to produce a first product where:
a. said first multiplication input is a first real number which can be a member of a first set of representations in a first finite-precision numeric format for a first set of number values and which can be a member of a second set of representations in a second finite-precision numeric format for a second set of number values
b. said second multiplication input is a second real number which can be a member of a third set of representations in a third finite-precision numeric format for a third set of number values and which can be a member of a fourth set of representations in a fourth finite-precision numeric format for a fourth set of number values, where:
i. said third set of representations in said third finite-precision numeric format has at least one member
ii. said third set of number values has at least one member
iii. said fourth set of representations in said fourth finite-precision numeric format has at least one member
iv. said fourth set of number values has at least one member
v. said third finite-precision numeric format is not the same as said fourth finite-precision numeric format
c. the method of said combined multiplication for computing said first product includes a first multiplication method for computing said first product when said second real number has a representation from said third set of representations in said third finite-precision numeric format and a corresponding number value from said third set of number values
d. the method of said combined multiplication for computing said first product includes a second multiplication method for computing said first product when said second real number has a representation from said fourth set of representations in said fourth finite-precision numeric format and a corresponding number value from said fourth set of number values
e. the method of said combined multiplication cannot compute said first product using said first multiplication method when said second real number does not have both a representation from said third set of representations in said third finite-precision numeric format and a corresponding number value from said third set of number values
whereby the method of said combined multiplication can accommodate a number to be multiplied that may be represented in different finite-precision numeric formats, and whereby said first multiplication method and hence the method of said combined multiplication can be implemented with lower cost than if said first multiplication method must be able to accommodate all allowed representations and number values of said second multiplication input.

12. The method of claim 11 in which the method of said combined multiplication cannot compute said first product using said second multiplication method when said second real number does not have both a representation from said fourth set of representations in said fourth finite-precision numeric format and a corresponding number value from said fourth set of number values, whereby said second multiplication method and hence the method of said combined multiplication can be implemented with lower cost than if said second multiplication method must be able to accommodate all allowed representations and number values of said second multiplication input.

13. The method of claim 11 in which said first multiplication input may only be represented in said first finite-precision numeric format, so that:
a. said first set of representations in said first finite-precision numeric format has at least one member
b. said first set of number values has at least one member
c. said second set of representations in said second finite-precision numeric format has no members
d. said second set of number values has no members
whereby the method of said combined multiplication computes the product of said first real number represented in said first finite-precision numeric format and said second real number, which can be represented in said third finite-precision numeric format or in said fourth finite-precision numeric format.

14. The method of claim 11 wherein:
a. said first set of representations in said first finite-precision numeric format has at least one member
b. said first set of number values has at least one member
c. said second set of representations in said second finite-precision numeric format has at least one member
d. said second set of number values has at least one member
e. said first finite-precision numeric format is not the same as said second finite-precision numeric format
whereby the method of said combined multiplication can accommodate multiplication of said first real number which can have representations in two different finite-precision numeric formats by said second real number which can also have representations in two different finite-precision numeric formats.

15. The method of claim 11 in which:
a. said first set of representations in said first finite-precision numeric format includes all possible representations in said first finite-precision numeric format
b. said first set of number values includes all possible number values supported by said first finite-precision numeric format
whereby the method of said combined multiplication can accept as said first multiplication input any number represented in said first finite-precision numeric format.

16. The method of claim 11 in which:
a. said first set of representations in said first finite-precision numeric format has at least one member but does not include all possible representations in said first finite-precision numeric format
b. said first set of number values has at least one member but does not include all possible values supported by said first finite-precision numeric format
whereby the method of said combined multiplication cannot accept as said first multiplication input all possible number representations in said first finite-precision numeric format.

17. The method of claim 11 in which:
a. said third set of representations in said third finite-precision numeric format includes all possible representations in said third finite-precision numeric format
b. said third set of number values includes all possible values supported by said third finite-precision numeric format
whereby the method of said combined multiplication can accept as said second multiplication input any number represented in said third finite-precision numeric format, but where the method of said combined multiplication may have lower cost when computing said first product when said second real number is represented in said fourth finite-precision numeric format and rather than in said third finite-precision numeric format, with the cost savings resulting from using said second multiplication method rather than said first multiplication method.

18. The method of claim 11 in which:
a. said third set of representations in said third finite-precision numeric format does not include all possible representations in said third finite-precision numeric format
b. said third set of number values does not include all possible values supported by said third finite-precision numeric format
whereby the method of said combined multiplication cannot accept as said second multiplication input every possible number represented in said third finite-precision numeric format.

19. The method of claim 11 in which:
a. said first set of representations in said first finite-precision numeric format has at least one member
b. said first set of number values has at least one member
c. said second set of representations in said second finite-precision numeric format has at least one member
d. said second set of number values has at least one member
e. said first set of number values and said second set of number values have no common members
whereby the method of said combined multiplication cannot accept said first multiplication input in said first finite-precision numeric format when said first multiplication input has a number value in said second set of number values and whereby the method of said combined multiplication cannot accept said first multiplication input in said second finite-precision numeric format when said first multiplication input has a number value in said first set of number values, so that the method of said combined multiplication must accommodate representations in at least two different finite-precision numeric formats for two different number values of said first multiplication input.

20. The method of claim 11 in which said third set of number values and said fourth set of number values have no common members, whereby the method of said combined multiplication cannot accept said second multiplication input in said third finite-precision numeric format when said second multiplication input has a number value in said fourth set of number values and whereby the method of said combined multiplication cannot accept said second multiplication input in said fourth finite-precision numeric format when said second multiplication input has a number value in said third set of number values, so that the method of said combined multiplication must accommodate representations in at least two different finite-precision numeric formats for two different number values of said second multiplication input.
